(19) United States
(12) Patent Application Publication
(10) Pub. No.: US 2004/0153011 A1
(43) Pub. Date: Aug. 5, 2004

(54) Massaging device with pebble-shaped massaging media

(76) Inventors: Yukio Noguchi, Tokyo (JP); Noriaki Takizawa, Tokyo (JP)

Correspondence Address: ROSENBERG, KLEIN & LEE, 3458 ELLICOTT CENTER DRIVE-SUITE 101, ELLICOTT CITY, MD, 21043, US

(21) Appl. No.: 10/354,057

(22) Filed: Jan. 30, 2003

(51) Int. Cl. A61H 7/00

(52) U.S. Cl. 601/17; 601/70; 601/136

(57) ABSTRACT

A massaging device includes a plurality of pebble-shaped massaging media which directly touch and surround the user's two feet. Thus, the pebble-shaped massaging media directly touch the user's two feet, so that the vibration force are fully and thoroughly transmitted to the user's two feet through the pebble-shaped massaging media, thereby enhancing the massaging effect for the user's two feet. In addition, the pebble-shaped massaging media are freely moving and rolling around the user's feet during container vibrating that provides a great massaging feeling to the user.

### BACKGROUND OF THE INVENTION

1. Field of the Invention

The present invention relates to a massaging device with pebble-shaped massaging media, and more particularly to a massaging device with pebble-shaped massaging media, wherein the pebble-shaped massaging media directly touch the user's two feet, so that the vibration force are fully and thoroughly, not limited to the foot-bottoms, transmitted to the user's two feet through the pebble-shaped massaging media, thereby enhancing the massaging effect for the user's two feet.

2. Description of the Related Art

A conventional massaging device comprises a container full of water, and a power source or vibration source is mounted under the container. In practice, the user's two feet are placed in the container and are surrounded by the water. Then, the vibration source mounted under the container transmits a vibration force into the container, so that the container and the water contained in the container are vibrated, thereby providing a massaging effect on the user's two feet surrounded by the water contained in the container.

However, the conventional massaging device has the following disadvantages.

1. The water contained in the container does not produce a stress concentration action on the user's two feet, so that the vibration force is mainly applying to foot-bottoms where is in directly contact with the container, thus cannot fully and thoroughly massage the user's two feet, thereby decreasing the massaging effect for the user's two feet.

2. As mentioned above, the massaging is only through the bottom of the container where might be built with some protruding tips. However, these protruding tips are fixed in its size and location. For lack of variation, the massaging effects are quite limited.

### SUMMARY OF THE INVENTION

The present invention has arisen to mitigate and/or obviate the disadvantage of the conventional massaging device.

The primary objective of the present invention is to provide a massaging device with pebble-shaped massaging media, wherein the pebble-shaped massaging media directly touch the user's two feet, thereby producing a stress concentration action, so that the vibration force are fully and thoroughly, not limited to the bottoms of feet, transmitted to the user's two feet through the pebble-shaped massaging media, thereby enhancing the massaging effect for the user's two feet.

Another objective of the present invention is to provide a massaging device with pebble-shaped massaging media, wherein the pebble-shaped massaging media, by its shape, can move and roll around and over the feet during massaging, thereby enhancing the massaging effect for the user's two feet.

Another objective of the present invention is to provide a massaging device with pebble-shaped massaging media, wherein the pebble-shaped media can rub and knock each other causing a visible movement and pleasing vibration sound that gives the users a better sense of massaging effect.

A further objective of the present invention is to provide a massaging device with pebble-shaped massaging media, wherein the pebble-shaped massaging media separate the user's two feet from the vibration source, so that the user's two feet do not directly contact the vibration source by isolation of the pebble-shaped massaging media, thereby protecting the user's two feet.

In accordance with the present invention, there is provided a massaging device, comprising a plurality of pebble-shaped massaging media which directly touch and surround a user's two feet, thereby enhancing the massaging effect for the user's two feet.

Preferably, the pebble-shaped massaging media are natural pebble or those made of glass, marble, plastic etc.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a massaging device with pebble-shaped massaging media in accordance with a preferred embodiment of the present invention; and

FIG. 2 is an exploded perspective view of the massaging device with pebble-shaped massaging media in accordance with the preferred embodiment of the present invention;

FIG. 3 is a side plan cross-sectional assembly view of the massaging device with pebble-shaped massaging media in accordance with the preferred embodiment of the present invention; and

FIG. 4 is a front plan cross-sectional assembly view of the massaging device with pebble-shaped massaging media in accordance with the preferred embodiment of the present invention.

### DETAILED DESCRIPTION OF THE INVENTION

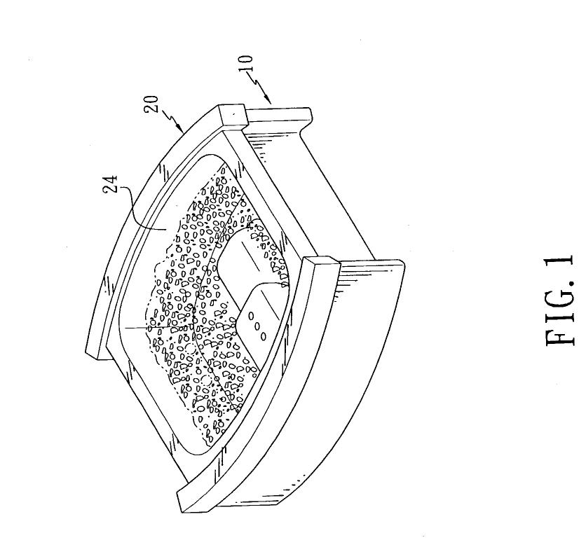

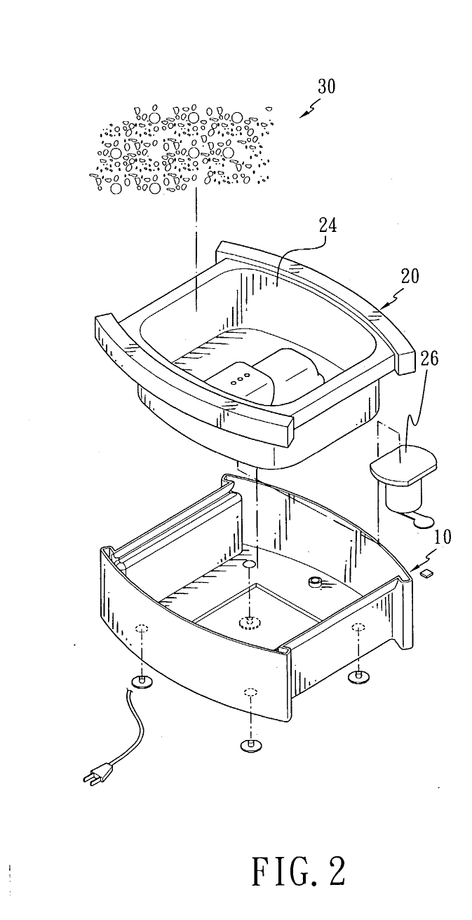

Referring to the drawings and initially to FIGS. 1 and 2, a massaging device with pebble-shaped massaging media in accordance with a preferred embodiment of the present invention comprises a support base 10, a vibrating container 20, and a plurality of pebble-shaped massaging media 30. The vibrating container 20, which is in one piece, is connecting with the support base 10 by the cushion (not shown) installed around it. Preferably, the pebble-shaped massaging media are natural pebble or those made of glass, marble, plastic etc.

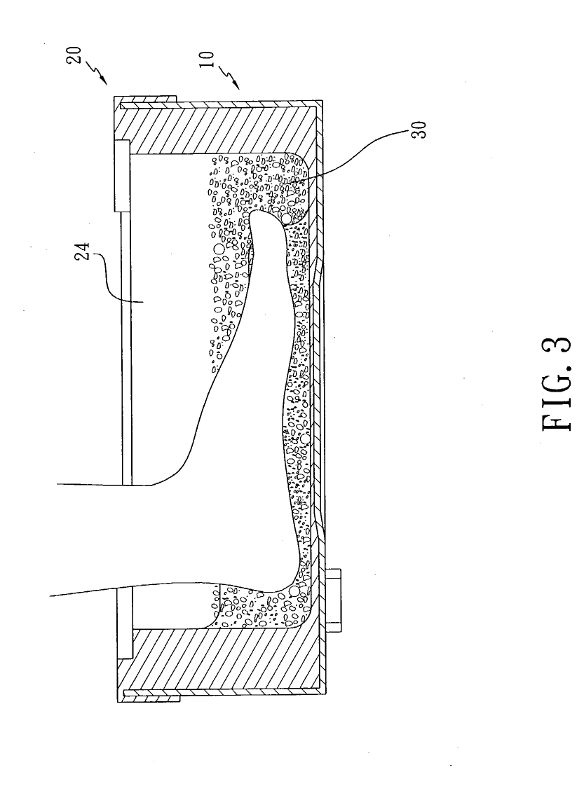

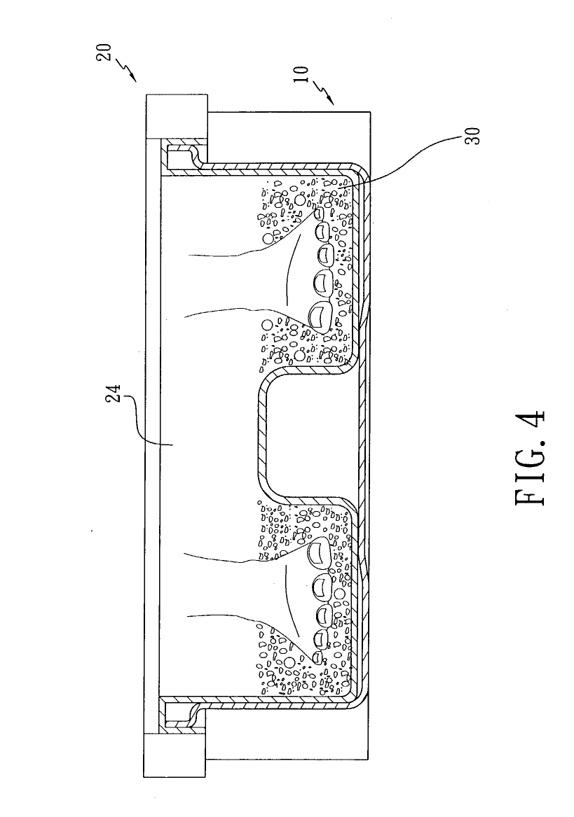

In practice, referring to FIGS. 3 and 4 with reference to FIGS. 1 and 2, the user's two feet are placed in the opened space 24 of the vibrating container and surrounded by the pebble-shaped massaging media 30 in the vibrating container 20. The vibration unit 26 is mounted under the vibrating container 20, so that the pebble-shaped massaging media 30 contained in the vibrating container 20 are been vibrating, rolling and moving, thereby providing a massaging effect on the user's two feet surrounded by the pebble-shaped massaging media 30.

Accordingly, the massaging device with pebble-shaped massaging media in accordance with the preferred embodiment of the present invention has the following advantages.

1. The pebble-shaped massaging media 30 surround and directly touch the user's two feet, so that the vibration massaging are fully and thoroughly applying to the user's two feet through the pebble-shaped massaging media 30, thereby enhancing the massaging effect for the user's two feet.

2. The pebble-shaped massaging media 30 made of solid material can transfer the vibration force rapidly and evenly, thereby enhancing the massaging effect for the user's two feet.

3. The pebble-shaped massaging media 30 separate the user's two feet from the vibration source, so that the user's two feet do not directly contact the vibration source by isolation of the pebble-shaped massaging media 30, thereby getting gentle massaging and thus protecting the user's two feet.

4. The pebble-shaped massaging media 30 are free with each other in the container so that they can move, roll and vibrate wholly around the user's feet during vibrating of the container and thus enhance the massaging effect for the user's two feet.

5. The user can see the movement of the pebble-shaped media and hear the pleasing vibration sound created by light knockings and rubbings between the media that gives the user better sense of massaging effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A massaging device, comprising a plurality of pebble-shaped massaging media which surround and directly touch a user's two feet, thereby enhancing the massaging effect for the user's two feet.

2. The massaging device in accordance with claim 1, wherein the pebble-shaped massaging media are natural pebble or those made of glass, marble, plastic etc.
